(19) United States
(12) Patent Application Publication
(10) Pub. No.: US 2017/0039509 A1
(43) Pub. Date: Feb. 9, 2017

(54) SYSTEM FOR PLANNING THE USE AND MANAGEMENT OF RESOURCES, PARTICULARLY FOR SCHEDULING DRIVING SHIFTS AND MACHINE SHIFTS IN TRANSPORTATION

(71) Applicant: MANAGEMENT, ARTIFICIAL INTELLIGENCE AND OPERATIONS RESEARCH SOCIETA' A RESPONSABILITA' LIMITATA, Lucca (IT)

(72) Inventor: Leopoldo GIRARDI, Pisa (IT)

(21) Appl. No.: 15/226,376

(22) Filed: Aug. 2, 2016

(30) Foreign Application Priority Data
Aug. 4, 2015 (IT) 102015000041585

(51) Int. Cl. G06Q 10/06

(52) U.S. Cl. CPC G06Q 10/063118; G06Q 10/06313

(57) ABSTRACT

A system for planning the use and management of resources includes a server provided with elements for identifying a first set of first homogeneous resources and at least one second set of second homogeneous resources. The system further includes elements for generating and storing a data structure, termed compatibility graph. The graph includes nodes that can be associated with real activities and dummy activities. The system is adapted to check for the existence of a partition on the compatibility graph that includes both nodes associated with real activities and nodes associated with dummy activities, wherein the existence of the partition is associable with the correct assignment of the resources to the real activities.

### CROSS REFERENCE TO RELATED APPLICATIONS

This application is related to and claims the benefit of Italian Patent Application No. 102015000041585, filed on Aug. 4, 2015, the contents of which are herein incorporated by reference in their entirety.

### TECHNICAL FIELD

The present disclosure relates to a system for planning the use and management of resources, in particular to a system for scheduling the shifts of personnel and of vehicles in public transportation. The disclosure relates further to a computer program that is consistent with the system.

### BACKGROUND

Situations are known in which the execution of certain actions requires the use of multiple resources, which must be assigned according to established methods, complying with constraints and attempting at the same time to optimize their management so as to make them available for new actions to be performed.

For example, the process of defining machine shifts and driving shifts in the urban environment requires the assignment of a driver to a vehicle in order to perform the task of user transportation. According to one approach that is applied especially in the field of urban transportation, first the shifts of the vehicles (hereinafter also termed machine shifts) are defined and only after are the shifts of the driving personnel (hereinafter also referenced as driving shifts) defined. In the urban environment the possibility for drivers to move, even on foot, from a location where a trip ends to the location where the next trip assigned to them begins is in fact usually ensured. In an urban environment, therefore, the definition of driving shifts is a function of the definition of machine shifts. The situation is more complex in out-of-town and suburban environments, where it is more difficult for drivers to travel on foot due to the greater distances between the starting stations (terminuses) or intermediate stations: in this field, therefore, there is a tendency to define driver shifts first and then machine shifts. However, this approach might lead to inconsistent situations, in which it is not possible to create driving shifts that are consistent with machine shifts, i.e., to build, in a second step, machine shifts that are consistent with the generated driving shifts.

For example, if the driver walks from the location where a first trip ends to the location where the next trip begins, the vehicle left at the end of the first trip might remain unattended. In this case, the shift of the vehicle, which at the end of the trip must be delivered to the depot or to another driver, would be inconsistent.

Moreover, it is not always actually possible for the driver to travel on foot, due to the great distances of the out-of-town environment, to go from the end of one trip to the beginning of the next trip. In this case it would not be possible to perform the next trip.

Shift scheduling, in addition to causing consistency problems, causes as many onerous problems in terms of use of resources of electronic computers, for example processing capacity of processors and memory utilization, since the algorithms that are present in the literature often require intensive processing activities and do not produce appreciable or even consistent results in relatively short times. In particular, assuming that the problem relates to machine shifts and driving shifts, after formalizing the problem according to a model (for example by using the minimum cost flow model on a graph or the Set Partitioning model) and after applying methods for resolution by means of algorithms known in the literature, the result is often unsatisfactory, since the set of allowable shifts is too large to be considered in its entirety. Moreover, by resorting to a heuristic approach the determined solution may usually be less than optimum After applying these known algorithms and after obtaining a result after a substantial amount of time, sometimes the result is not usable, for example because a driver is assigned two successive shifts in remote locations or because the location where the vehicles are picked up or delivered at the beginning or at the end of the driving shift is not duly taken into account.

### SUMMARY

The present disclosure overcomes the limitations of the background art described above, by devising a new system capable of finding an allowable solution of a decision-making problem, allowing to manage and coordinate limited resources and activities.

Within this aim, the present disclosure provides a system to improve the planning of shifts, particularly of service shifts of personnel and of the shifts of the machines used to perform the service.

The present disclosure maximizes or minimizes a goal function associated with a decision-making problem.

The present disclosure allows to assign correctly all the resources required to perform a service, at the same time allowing their efficient reassignment and revocation.

The present disclosure coordinates the management of resources the assignment and revocation of which is a function of the assignment and revocation of other resources.

The present disclosure also devises a computer program that allows to plan the use of resources, be they human beings or machines, reducing the computing power and the calculation time required.

The present disclosure further provides a structure that is simple, relatively easy to provide in practice, safe in use, effective in operation, and relatively low in cost.

### BRIEF DESCRIPTION OF THE DRAWINGS

Further characteristics and advantages of the system according to the present disclosure will become better apparent from the detailed description that follows, given by way of nonlimiting example, accompanied by the corresponding figures, wherein:

FIG. 1 is a block diagram of a system according to the present disclosure;

FIG. 2 is a diagram of a computer program according to the present disclosure; and

FIG. 3 is a view of an aspect of the system according to the present disclosure.

### DETAILED DESCRIPTION OF THE DRAWINGS

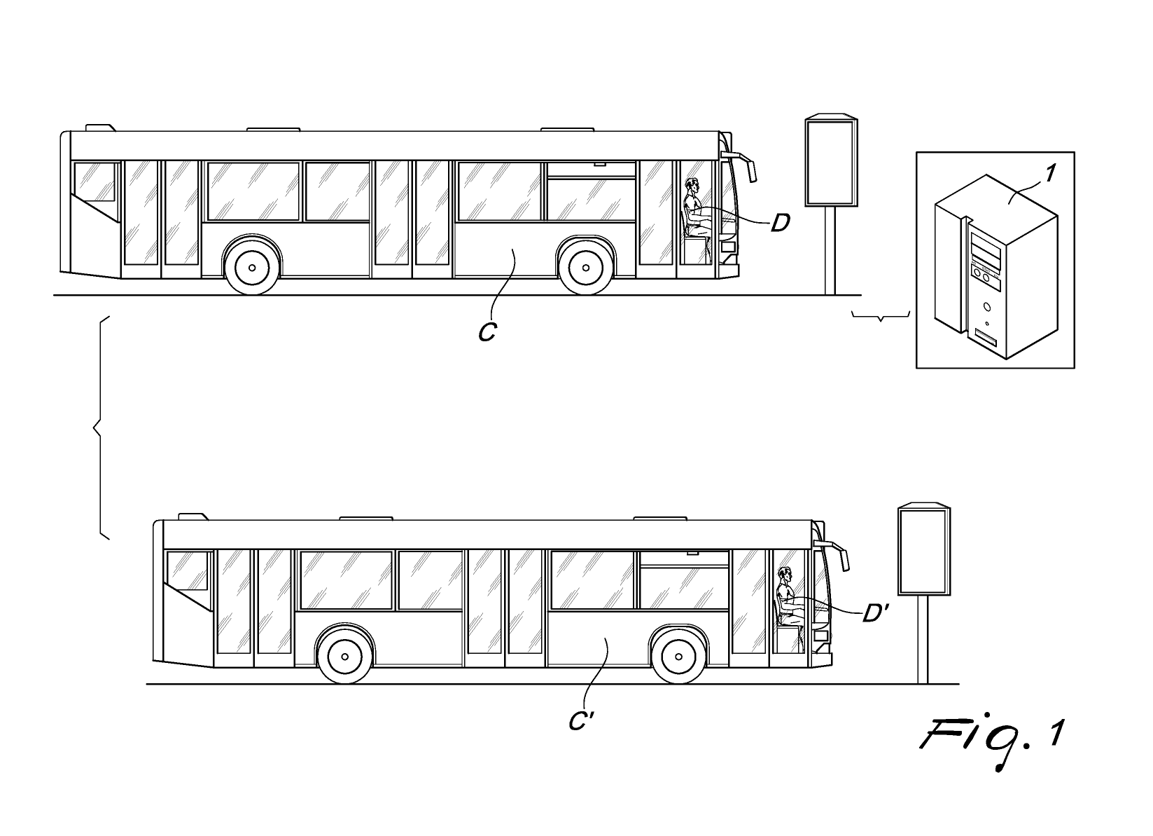

An exemplifying architecture of the system according to the present disclosure is summarized in the block diagram of FIG. 1, which shows a server 1 configured for planning the use and management of resources.

Hereinafter it will be assumed, merely for the sake of simplicity in description and in a nonlimiting manner, that the resources to be managed and the use of which is to be planned are drivers and vehicles, for example buses, which perform the urban and out-of-town people transportation service. Consistently, FIG. 1 shows a plurality of vehicles C, C′, each driven by at least one driver D, D′. Furthermore, it will be assumed that unless the contrary is stated explicitly the vehicles cannot be left unattended but must be delivered by the driver to whom they are assigned to an appropriate assembly center (depot) or to another driver.

The server 1 manages a plurality of information items related to drivers and vehicles that are necessary for the management of the transportation service. The server 1 comprises known hardware architectures and is arranged geographically in a location that is preferably remote with respect to the vehicles C, C′ and to the drivers D, D′, with whom it is preferably able to communicate by means of a telecommunications network, not shown in FIG. 1.

The server 1 can comprise an electronic computer or, more usually, a data processing center that has limited computing power and is capable of running a computer program the characteristics of which will be clarified hereinafter. In particular, the server 1 comprises at least the means 10, 11, 12, 13, 14, 15 and 16. Such means are preferably implemented as software modules of a computer program that can be run by the server 1.

The means 10 are adapted to identify a first set of first homogeneous resources and at least one second set of second homogeneous resources. In particular, the first resources comprise the set of the drivers of a transportation company and the second set comprises the set of the vehicles of the company that can be driven by the drivers. The means 10 are capable of establishing which drivers and which vehicles are available, for example on a given day, to perform the transportation service.

The means 11 are adapted to identify a set of first tasks, the execution and completion of which requires the use of at least one of the first resources and optionally at least one of the second resources. These tasks, for example, are constituted by a trip from a starting site to a destination site performed by a driver by using one of the vehicles available. The means 11 are capable of establishing which drivers and which vehicles can be assigned to perform the trips. For example, the means 11 can indicate that the trip L, which relates to a route, can be performed by the driver D by using the vehicle C and that the trip M, which relates to another route and occurs after the trip L, can be performed by the same driver D or by another driver D′, using another vehicle C′, after delivering the vehicle C to the depot or to the delivery location. It is assumed that the driver D goes to the location where the vehicle C′ is located on foot or by using the vehicle C or for example as a passenger on another vehicle.

The means 12 are similar to the means 11, with the difference that they identify a set of second tasks/activities but are of a dummy type, i.e., tasks that do not need to be actually performed. For example, it is assumed that once the trip L has ended, the driver D goes, by using the vehicle C, to the location where the second trip M begins (the driver, as mentioned above in relation to the means 11, actually goes from L to M without using the vehicle C, i.e., on foot or on another vehicle). The driver D has actual control of the vehicle C only during the trip L, at the end of which the vehicle C might again be available and placed under the responsibility of the transportation company or another driver D′. Preferably, the dummy tasks are of two types: dummy tasks (which belong to a set F) that represent the assignment of the vehicle at the end of the trip and dummy activities (belonging to a set I) that represent the provision of the vehicle at the beginning of the trip.

The means 13 are adapted to generate and store a data structure, known as compatibility graph G, which comprises first nodes that can be associated with the real tasks and second nodes that can be associated with second dummy tasks, wherein the first nodes and the second nodes can be correlated in manners that will become better apparent hereinafter.

The compatibility graph G, by means of the nodes and arcs, expresses the relations that occur among the various tasks to which resources are to be assigned and the relations that occur between these tasks and the dummy tasks to which resources that can be assigned or revoked with respect to the first nodes to perform the associated real task are in turn assigned, albeit virtually.

In the preferred embodiment, the compatibility graph G comprises the nodes N joined by the arcs A, wherein:

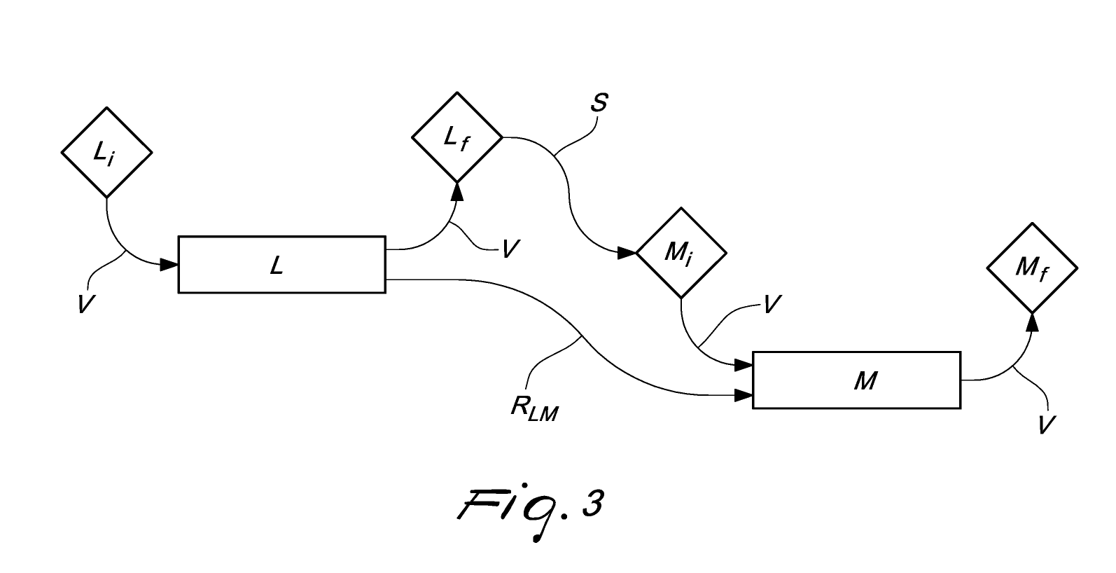

n=T∪ {O, D}∪ I∪ F

wherein the set T comprises the real activities, I is the set of the dummy activities prior to the beginning of the real activity to be performed (for example a trip), F is the set of dummy activities at the end of each real activity to be performed, and O and D, which do not represent “real” activities, corresponds to the depot nodes, which are not shown in the figure and the presence of which is optional, and in which it is imagined that the shifts begin and end. In FIG. 3, the nodes of the graph are indicated by the same symbol used to indicate the associated real activity or trip.

The means 14 are adapted to correlate each one of the first nodes with second nodes (which corresponds to zero time activities to be performed for assignment or provision of the vehicle). In particular, two nodes that correspond to dummy activities are usually correlated with each node that corresponds to a real activity. Preferably, the means 14 associate with each real task two dummy tasks, one related to the period after the trip, indicated in FIG. 3 by the nodes L_{f} and M_{f}, and one related to the period before the beginning of the trip, indicated in FIG. 3 as task L, and M. For example, as shown in FIG. 3, the node L is correlated with the pair of nodes L_{f} and Lᵢ, while the node M is correlated with the two nodes M_{f} and Mᵢ.

In particular, for each i, i ∈ T, related to real activities, dummy activities are also considered such that:
i, i ∈ I, which represent the activities for provision of the vehicle at the beginning of the trip;
i, i ∈ F, which represent the activities for assignment of the vehicle at the is end of the trip.

The set of the arcs A that connect nodes related to real activities is replaced with a set of arcs A such that:
1. ∀(i, j)∈A, (ī, [symbol] )∈Ā
2. ∀i∈T, (i, ī)∈Ā [symbol] (i, i)∈Ā
3. ∀i∈T, (O, ī)∈Ā [symbol] (i, D)∈Ā
   wherein, considering 1. (i.e., ∀(i,j)∈A,(i, j)∈A) one has that 2. (i.e., ∀i∈T,(i,i)∈A [symbol] (i,i)∈A) represents connections of real activities with the dummy activities and 3. (i.e., ∀iET,(O, i)∈A [symbol] (i,D)∈A) represents travels on a vehicle from and toward the depots. Every other arc in A represents travels of the driver (for example on foot, but in any case without a vehicle) or waits between two activities to be covered (dummy or real). In particular, the arc (i, j), wherein i ∈ T and j ∈ T, is a travel (for example on foot, but in any case without the vehicle C that was assigned previously to him) from the end of the trip i to the beginning of the trip j.

The means 15 are adapted to define allowable sequences of first and second nodes on the basis of a criterion. For example, the decision-making problem of assigning driving shifts might be formalized by using the Set Partitioning model and by defining P as the set of allowable paths on G; wherein for each shift (path) p ∈ P having a cost Cₚ there is a Boolean variable xₚ that has a value 1 if the shift p belongs to the solution and is 0 otherwise. The criterion might comprise selecting a set of allowable paths that comprise the optimum solution or values that approximate the optimum solution. In particular, the optimum solution, with the problem as formalized above, would be given by:

min{Σ_{p ∈ P}cₚxₚ: Σ_{p ∈ P}aᵢₚxₚ=1 i ∈ N, xₚ ∈{0, 1}p ∈ P}

where the coefficients aᵢₚ have the value 1 if the activity i belongs to the shift p and 0 otherwise.

The means 16 are adapted to identify (i.e., find, locate) an assignment of all the first and second nodes to an allowable path (for example by means of set partitioning algorithms that are well-known in the literature).

If the means 16 identify this consistent assignment, then this assignment represents a partition of activities (dummy and not dummy) of the compatibility graph. The identification of this partition (i.e., paths on the graph, wherein the paths are composed of dummy and real activities) allows to ensure that the driving shifts of the drivers and the machine shifts are consistent. The shift scheme that is obtained ensures coverage of the transportation service by the drivers but at the same time the correct management of the machines is insured, since the necessary resources have been assigned to all the real activities. In other words, the existence of a shift arrangement for the machines that is consistent with the driving shifts and is allowable is ensured, indeed due to the fact that all the dummy and real activities have been assigned to the driving shifts.

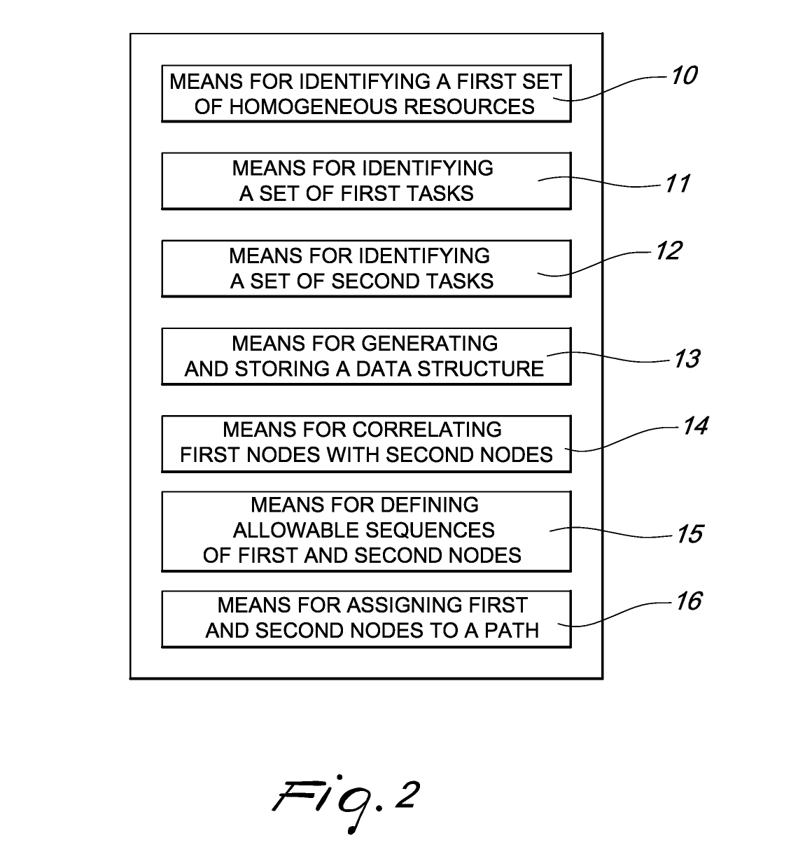

FIG. 2 is a schematic view of a computer program that implements the software modules of the server 1.

FIG. 3 shows a portion of the compatibility graph G (which may comprise a plurality of nodes), and in particular a portion of the graph that comprises two nodes L and M that can be associated with two trip activities and various dummy activities, indicated as diamonds, Lᵢ, L_{f}, Mᵢ, M_{f}. In particular, this graph portion comprises a first arrow Rim that is adapted to connect the nodes L and M; a second arrow S adapted to connect the second nodes L_{f} and Mᵢ; and third arrows V adapted to connect the second nodes Lᵢ, L_{f}, Mᵢ, M_{f} to the respective first nodes L and M. In particular, the first arrow Rim can be associated with the fact that the driver leaves the vehicle C used is for the trip associated with the node L and goes, without the vehicle C, to the location where the second vehicle C′ is located to perform the second trip associated with the node M. The node L_{f} (or M_{f}) can be associated with the assignment, by a driver, of the vehicle used to perform the trip associated with the node L after said trip has been performed. The arrow V that connects the node L to L_{f} can be associated with the dummy continuation, by the driver

D or by another driver, on the vehicle used to perform the trip associated with the node L after such trip has been performed. The node Mᵢ (or Lᵢ) can be associated with the assignment, by the driver D or by another driver D′, of a vehicle with which he goes to the starting point where the trip associated with the node M begins the trip to the node M is performed by using this vehicle.

The arrow V that connects the node Mᵢ to the node M can be associated with the fact that a driver can go with a vehicle to the beginning of the trip associated with the node M and perform such trip with that vehicle. The scheme proposed for the nodes L and M is proposed again for all the nodes that are present in the graph G. If the verification for all the nodes of the graph that is shown visually in FIG. 3 by the linking of the nodes by means of the arrows shows that there is an allowable path of nodes of real activity (linked by means of the arrow Rₗₘ) and of dummy activity, then the existence of such allowable path of the nodes of the graph ensures both the consistent assignment of machine shifts and of personnel shifts.

Obviously, the person skilled in the art understands that this verification must be extended to all pairs of nodes of the graph G where a pair of nodes represents real activities that occur at separate moments. This verification further occurs by means of the use of the processing means of the server 1. In particular, the means 10, 11, 12, 13, 14, 15 and 16 can be provided as modules of a computer program that is run by the server 1.

In particular, the system thus conceived allows to overcome the quality limitations of the background art, allowing to assign the resources for performing a service correctly and consistently. This system is found to be particularly advantageous for defining machine shifts and driver shifts especially in relation to out-of-town transportation, where, differently from the urban case, the assignment of a shift to a driver cannot disregard the location where the vehicle is left during the execution of his driving shift due to the great distances that might not be allowed to recover the vehicle. Clearly, numerous modifications are evident and can be performed promptly by the person skilled in the art without abandoning the protective scope of the present disclosure. For example, although the term “activity” has been used to reference operations related to a trip, for example the assignment and delivery of a vehicle, these activities might also not provide for the assignment of a vehicle (for example cleaning operations).

For example, it is obvious for the person skilled in the art that although reference has been made to the case of transportation, the disclosure finds application in all fields in which it is necessary to schedule the allocation of multiple resources to real activities, for example to tasks that can be performed by a processor.

1. A system for planning the use and management of resources, the system comprising a server provided with:
means for identifying a first set of first homogeneous resources and at least one second set of second homogeneous resources;
means for identifying a set of first tasks, which correspond to a plurality of real activities, the execution and completion of which requires the use of at least one of said first resources and optionally at least one of said second resources; said first and second resources being revokable or assignable temporarily to said first tasks;
means for identifying a set of second tasks, which correspond to a plurality of dummy activities, and means for assigning at least temporarily to said second tasks a first resource and a second resource revoked from one of said first tasks or from one of said second tasks or a first resource and a second resource that can be assigned to a first task or a second task;
means for generating and storing a data structure, termed compatibility graph, which comprises first nodes that can be associated with said first tasks and second nodes that can be associated with said second tasks;
means for correlating each one of said first nodes with at least one pair of second nodes;
means for defining allowable sequences of said first and second nodes on the basis of a criterion; and
means for assigning said first and second nodes to an allowable path on said graph.

2. The system according to claim 1, wherein said means for correlating each one of said first nodes with second nodes are configured so that one of said second nodes has assigned thereto a first resource and a second resource revoked from the task associated with one of said first nodes; another one having assigned thereto first resources and second resources to be assigned to said first task associated with said first node.

3. The system according to claim 1, wherein said allowable path comprises a non-cyclic sequence of first and second nodes; and wherein for each pair of first nodes connected sequentially, one of said first nodes is assigned/revoked a first resource and/or a second resource revoked/assigned to the other of said pair of first sequentially connected nodes.

4. The system according to claim 1, wherein said allowable path comprises a plurality of non-cyclic sequences of first nodes and second nodes; wherein said first sequence of first nodes corresponds to two distinct machine shifts for the execution of services, said second sequence of second nodes corresponds to the execution of a service on a same machine.

5. The system according to claim 1, wherein said criterion comprises selecting the allowable path from a set of first allowable paths by means of linear programming methods, optimizing a goal function associated with a minimum cost flow problem or a partitioning problem of said compatibility graph.

6. The system according to claim 1, wherein said first and second resources are of the time type, for example the shift of an operator and the time of use of a machine or machine shift; said first tasks being associable with real activities; said second tasks being associable with dummy activities.

7. A computer program for planning the use and management of resources, the program being stored on an information technology medium and comprising instructions of the software type adapted to implement the system according to claim 1.
